(19) United States
(12) Patent Application Publication
(10) Pub. No.: US 2022/0140852 A1
(43) Pub. Date: May 5, 2022

(54) ONE-PIECE MAGNETIC ATTRACTION TYPE MOBILE PHONE PROTECTION SHELL

(71) Applicant: Dongguan Chengkang Electronics Co., Ltd., Dongguan (CN)

(72) Inventor: Deming Zeng, Liuyang (CN)

(21) Appl. No.: 17/575,662

(22) Filed: Jan. 14, 2022

(30) Foreign Application Priority Data
Sep. 14, 2021 (CN) 202122221854.0

(51) Int. Cl. H04B 1/3888; A45C 11/00; A45C 13/10

(52) U.S. Cl. CPC H04B 1/3888; A45C 2011/002; A45C 13/1069; A45C 11/00

(57) ABSTRACT

A one-piece magnetic attraction type mobile phone protection shell is provided, including a back plate, and a covered edge formed on the back plate at one time through secondary injection molding. The covered edge builds, along a circumferential edge of the back plate, a groove-shaped structure into which a smartphone is embedded; the back plate has a base plate, a surface plate that covers and is fitted to a top surface of the base plate, and a bottom plate that covers and is fitted to a bottom surface of the base plate; a hollow part is arranged on the base plate; a magnetic sheet subassembly flush with the base plate is embedded into the hollow part; and the magnetic sheet subassembly is clamped and fixed in the hollow part by the surface plate and the bottom plate.

### TECHNICAL FIELD

The present disclosure relates to the technical field of smart phones, specifically to a one-piece magnetic attraction type mobile phone protection shell.

### BACKGROUND

A mobile phone protection shell is a smart phone peripheral product made of metal, plastic, silica gel, etc. With technical iteration, the prior art proposes a mobile phone protection shell 1′ as shown in FIG. 1, the back of which is provided with a magnetic sheet subassembly 2′, so that a smart phone 3′ can be sucked on a magnetic-attractable fixed object through the mobile phone protection shell 1′ and is placed and fetched at a will. This is convenient and easy to use and relieves hands of a user to an extremely large extent.

The above-mentioned mobile phone protection shell 1′ in the prior art is implemented in many ways as shown in FIG. 2: Firstly, a main body 11′ of the protection shell 1′ is injection-molded, and then a groove 12′ into which the magnetic sheet subassembly 2′ is buried is machined by Computer Numerical Control (CNC) on an inner wall of the back of the main body 11. The magnetic sheet subassembly 2′ is adhered in the groove 12′. One layer of surface paper 13′ matched with the shape of an opening of the groove 12′ is attached to the magnetic sheet subassembly 2′, so as to shield the groove 12′ and the magnetic sheet subassembly 2′ from the inside. A decorative layer cooperating with the groove 12′ is screen-printed on an outer wall of the back of the main body 11′, so as to shield the groove 12′ and the magnetic sheet subassembly 2′ from the outside.

The applicant has found in practice that in the above-mentioned mobile phone protection shell in the prior art, the back of the main body 11′ is set to be thicker, so that the mobile phone protection shell has sufficient structural strength when the groove 12′ is machined by the CNC. In addition, since the surface paper 13′ is directly exposed on the inner wall of the back of the main body 11′, an inner-side surface of the back of the main body 11′ is not flat enough, and the surface paper 13′ is easy to fall off. Furthermore, the screen-printed decorative layer on the outer wall of the back of the main body 11′ is easy to scratch.

### SUMMARY

The present disclosure aims to provide a one-piece magnetic attraction type mobile phone protection shell for the deficiencies in the above-mentioned situation. The technical solutions are as follows.

A one-piece magnetic attraction type mobile phone protection shell is provided,

including a back plate, and a covered edge formed on the back plate at one time through secondary injection molding. The covered edge builds, along a circumferential edge of the back plate, a groove-shaped structure into which a smartphone is embedded;

the back plate has a base plate, a surface plate that covers and is fitted to a top surface of the base plate, and a bottom plate that covers and is fitted to a bottom surface of the base plate; a hollow part is arranged on the base plate; a magnetic sheet subassembly flush with the base plate is embedded into the hollow part; and the magnetic sheet subassembly is clamped and fixed in the hollow part by the surface plate and the bottom plate.

Compared with the prior art, the present disclosure has the beneficial effects:

(1) The base plate is provided with the hollow part for embedding the magnetic sheet subassembly. The machining method for the hollow part is simpler and more convenient than CNC slotting, so that a material does not need to be additionally thickened for CNC slotting.

(2) The surface plate, the base plate, and the bottom plate are fitted in sequence, and the magnetic sheet subassembly is clamped and fixed in the hollow part through the surface plate and the bottom plate. The entire back plate is one-piece, so that the structural strength, the smoothness, and the flatness are all higher than those in the prior art.

The present disclosure is further described below in combination with the accompanying drawings of the specification and specific implementation modes.

### BRIEF DESCRIPTION OF THE DRAWINGS

FIG. 1 is a schematic structural diagram of a mobile phone protection shell provided in the prior art.

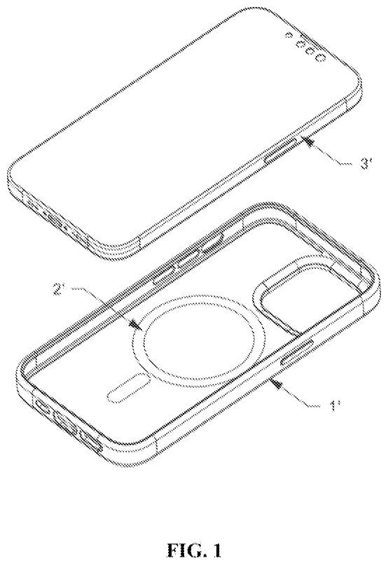

FIG. 2 is an exploded schematic structural diagram of the mobile phone protection shell shown in FIG. 1.

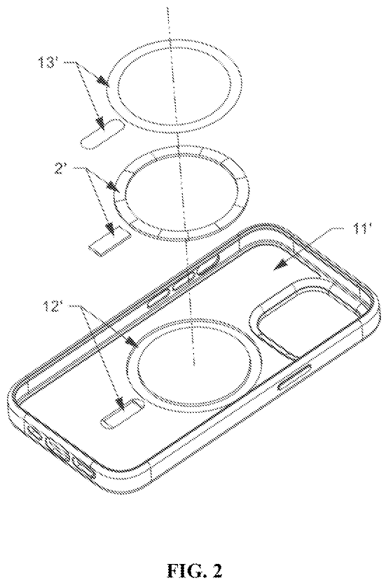

FIG. 3 is a schematic structural diagram of the present disclosure.

FIG. 4 is an exploded schematic structural diagram of the present disclosure.

FIG. 5 is a schematic structural diagram of a back plate in the present disclosure.

### DETAILED DESCRIPTION OF THE EMBODIMENTS

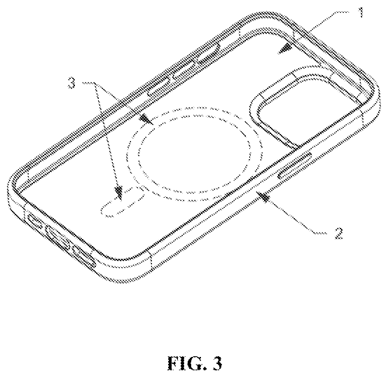

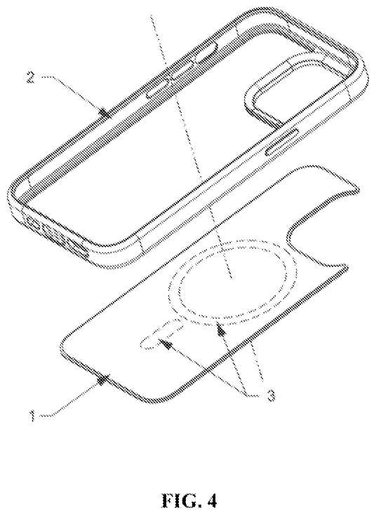

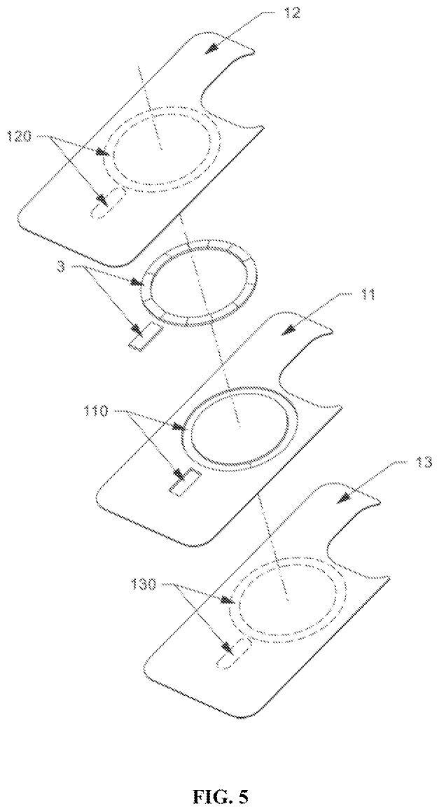

As shown in FIG. 3 to FIG. 5, a one-piece magnetic attraction type mobile phone protection shell is provided,

including a back plate 1, and a covered edge 2 formed on the back plate 1 at one time through secondary injection molding. The covered edge 2 builds, along a circumferential edge of the back plate 1, a groove-shaped structure into which a smartphone is embedded.

the back plate 1 has a base plate 11, a surface plate 12 that covers and is fitted to a top surface of the base plate 11, and a bottom plate 13 that covers and is fitted to a bottom surface of the base plate 1; a hollow part 110 is arranged on the base plate 11; a magnetic sheet subassembly 3 flush with the base plate 11 is embedded into the hollow part 110; and the magnetic sheet subassembly 3 is clamped and fixed in the hollow part 110 by the surface plate 12 and the bottom plate 13.

By adopting the above-mentioned implementation mode, in the one-piece magnetic attraction type mobile phone protection shell provided by the present disclosure, since the base plate 11 is provided with the hollow part 110 for embedding the magnetic sheet subassembly 3, and the machining method for the hollow part 110 is simpler and more convenient than CNC slotting, a material does not need to be additionally thickened for CNC slotting. At the same time, the surface plate 12, the base plate 11, and the bottom plate 13 are fitted in sequence, and the magnetic sheet subassembly 3 is clamped and fixed in the hollow part 110 through the surface plate 12 and the bottom plate 13, so that the entire back plate 1 is one-piece, and the structural strength, the smoothness, and the flatness are all higher than those in the prior art.

In one preferable implementation mode, the magnetic sheet subassembly 3 includes a plurality of sheet-like magnets tiled in the hollow part 110.

In another preferable implementation mode, the base plate 11 is a polycarbonate (PC) sheet material. The surface plate 12 and the bottom plate 13 are respectively polyethylene terephthalate (PET) sheet materials. The covered edge 2 is a thermoplastic polyurethane (TPU) material.

For the implementation mode that the surface plate 12 and the bottom plate 13 are respectively the PET sheet materials, the surface plate 12 and the bottom plate 13 are non-transparent PET sheet materials, or the surface plate 12 and the bottom plate 13 are transparent PET sheet materials.

For the implementation mode that the surface plate 12 and the bottom plate 13 are respectively the transparent PET sheet materials, a first non-transparent part 120 is prefabricated on a bottom surface of the surface panel 12, and a second non-transparent part 130 is prefabricated on a top surface of the bottom plate 13. Since the first non-transparent part 120 and the second non-transparent part 130 are respectively provided on the transparent surface plate 12 and bottom plate 13, an interior trim embedded into the back plate 1 can be formed. Furthermore, the first non-transparent part 120 is located on a surface of the surface plate 12 that downwards cooperates with the base plate 11, and the second non-transparent part 130 is located on a surface of the bottom plate 13 that upwards coordinates with the base plate 11, so that it can be ensured that the surface of the back plate 1 has perfect smoothness and flatness, and the first non-transparent part 120 and the second non-transparent part 130 will not be scratched and fall off

Further, the first non-transparent part 120 and the second non-transparent part 130 respectively cover the hollow part 110 and the magnetic sheet subassembly 3.

Optionally, the non-transparent part 120 and the second non-transparent part 130 are non-transparent layers formed in a screen-printing or coating or adhering manner.

Those skilled in the art can obtain various other corresponding changes and transformations according to the structure and principle disclosed in the present disclosure, and all these changes and transformations fall within the protection scope of the present disclosure.

What is claimed is:

1. A one-piece magnetic attraction type mobile phone protection shell,
comprising a back plate, and a covered edge formed at one time through secondary injection molding, wherein the covered edge builds, along a circumferential edge of the back plate, a groove-shaped structure into which a smartphone is embedded;
the back plate has a base plate, a surface plate that covers and is fitted to a top surface of the base plate, and a bottom plate that covers and is fitted to a bottom surface of the base plate; a hollow part is arranged on the base plate; a magnetic sheet subassembly flush with the base plate is embedded into the hollow part; and the magnetic sheet subassembly is clamped and fixed in the hollow part by the surface plate and the bottom plate.

2. The one-piece magnetic attraction type mobile phone protection shell according to claim 1, wherein the magnetic sheet subassembly comprises a plurality of sheet-like magnets tiled in the hollow part.

3. The one-piece magnetic attraction type mobile phone protection shell according to claim 1, wherein the base plate is a polycarbonate (PC) sheet material; the surface plate and the bottom plate are respectively polyethylene terephthalate (PET) sheet materials; and the covered edge is a thermoplastic polyurethane (TPU) material.

4. The one-piece magnetic attraction type mobile phone protection shell according to claim 3, wherein the surface plate and the bottom plate are respectively non-transparent PET sheet materials.

5. The one-piece magnetic attraction type mobile phone protection shell according to claim 3, wherein the surface plate and the bottom plate are respectively transparent PET sheet materials.

6. The one-piece magnetic attraction type mobile phone protection shell according to claim 5, wherein a first non-transparent part is prefabricated on a bottom surface of the surface panel, and a second non-transparent part is prefabricated on a top surface of the bottom plate.

7. The one-piece magnetic attraction type mobile phone protection shell according to claim 6, wherein the first non-transparent part and the second non-transparent part respectively cover the hollow part and the magnetic sheet subassembly.

8. The one-piece magnetic attraction type mobile phone protection shell according to claim 6, wherein the non-transparent part and the second non-transparent part are non-transparent layers formed in a screen-printing or coating or adhering manner.
